(19) United States
(12) Patent Application Publication
(10) Pub. No.: US 2025/0173835 A1
(43) Pub. Date: May 29, 2025

(54) OBJECT REMOVAL WITH FOURIER-BASED CASCADED MODULATION GAN

(71) Applicant: SAMSUNG ELECTRONICS CO., LTD., Suwon-si (KR)

(72) Inventors: Razieh KAVIANI BAGHBADERANI, San Jose, CA (US); Shuangquan WANG, San Diego, CA (US)

(73) Assignee: SAMSUNG ELECTRONICS CO., LTD., Suwon-si (KR)

(21) Appl. No.: 18/794,821

(22) Filed: Aug. 5, 2024

Related U.S. Application Data
(60) Provisional application No. 63/603,427, filed on Nov. 28, 2023.

(51) Int. Cl. G06T 5/60; G06T 5/10; G06T 5/77; G06T 7/11

(52) U.S. Cl. CPC G06T 5/60; G06T 5/10; G06T 5/77; G06T 7/11; G06T 2207/20016; G06T 2207/20056; G06T 2207/20084

(57) ABSTRACT

Methods and systems for performing image object removal, including: obtaining an input image comprising an object; obtaining a mask corresponding the object in the input image; generating a masked image based on the input image and the mask, wherein the masked image comprises a missing area corresponding to the object; providing the masked image to a Fourier-based encoder; and generating a composed image by providing an output of the encoder to a Fourier-based cascaded decoder comprising a Fourier-based global modulation decoder cascaded with a Fourier-based spatial modulation decoder, wherein the object is not included in the composed image

### CROSS-REFERENCE TO RELATED APPLICATION

This application claims the priority benefit under 35 U.S.C. § 119 (e) of U.S. Provisional Application No. 63/603,427, filed on Nov. 28, 2023, the disclosure of which is incorporated by reference in its entirety as if fully set forth herein.

### TECHNICAL FIELD

The disclosure generally relates to image object removal. More particularly, the subject matter disclosed herein relates to a Fourier-based cascaded modulation generative adversarial network (GAN) architecture which may be used to perform coarse-to-fine image generation to fill in missing areas of an image after removal of an object.

### SUMMARY

Object removal may be used to erase an unwanted object or other user-defined regions from an image, and fill in missing regions of the image caused by removal of the object such that the inpainted areas are visually indistinguishable from the real areas. Generating image content with complex geometric structures and high-resolution details remains challenging, especially when the missing regions are large.

Some previous approaches to object removal may be divided into four categories. For example, patch-based methods may involve synthesizing the content inside the missing regions by using the textures of other patches in the image. However, these methods may have difficulty in inferring semantic structure within the missing region.

Two-stage frameworks may include a first stage which constructs the global structure of the image content, and a second stage which synthesizes the local textures. However, the size of the missing area is a challenge because the structure of the image cannot be estimated accurately.

Generative-based methods may involve augmenting the latent representation with a stochastic noise vector to enable various image generation with respect to the rest of the image. However, the performance of this method depends on the training data, and the model may perform poorly with novel image textures.

Transformer-based methods may incorporate an attention mechanism on the structure which may be computed in a low-resolution coarse image. However, these methods may result in poorly-synthesized texture when low-resolution images are used.

To overcome these issues, systems and methods described herein are directed to a modulation-based generative network structure including a cascaded global-spatial decoder, which includes a first decoder specializing in global feature learning cascaded with a second decoder specializing in spatial feature learning in order to better generate image content in a coarse-to-fine manner. In addition, embodiments may use fast Fourier-based feature learning in the encoder and in the global decoder and the spatial decoder.

The above approaches improve on previous methods because they may better perform image generation in a coarse-to-fine manner. In addition, the use of Fourier-based convolution by embodiments may enlarge the receptive field of the network to attend to the entire feature map. As a result, embodiments may effectively handle both structure and texture of the image, and may produce realistic inpainting results for missing regions having any shapes or sizes.

In an embodiment, a method of performing object image removal comprises: obtaining an input image comprising an object; obtaining a mask corresponding the object in the input image; generating a masked image based on the input image and the mask, wherein the masked image comprises a missing area corresponding to the object; providing the masked image to a Fourier-based encoder; and generating a composed image by providing an output of the encoder to a Fourier-based cascaded decoder comprising a Fourier-based global modulation decoder cascaded with a Fourier-based spatial modulation decoder, wherein the object is not included in the composed image.

In an embodiment, a system for performing object image removal comprises: a masking module configured to: obtain an input image comprising an object; obtain a mask corresponding the object in the input image; generate a masked image based on the input image and the mask, wherein the masked image comprises a missing area corresponding to the object; a Fourier-based encoder configured to generate features based on the masked image; and a Fourier-based cascaded decoder comprising a Fourier-based global modulation decoder cascaded with a Fourier-based spatial modulation decoder, wherein the cascaded decoder is configured to generate a composed image based on the features, and wherein the object is not included in the composed image.

### BRIEF DESCRIPTION OF DRAWING

In the following section, the aspects of the subject matter disclosed herein will be described with reference to exemplary embodiments illustrated in the figures, in which:

FIG. 1 is a block diagram showing an image object removal system, according to embodiments.

FIG. 2 is a block diagram showing an encoder and a cascaded decoder included in an image object removal system, according to embodiments.

FIG. 3A is a block diagram showing global modulation block cascaded with a spatial modulation block, according to embodiments.

FIG. 3B is a block diagram showing global modulation block cascaded with a spatial modulation block, according to embodiments.

FIG. 4 is a block diagram showing fast Fourier synthesis block, according to embodiments.

FIG. 5 is a block diagram showing fast Fourier residual block, according to embodiments.

FIG. 6 is a block diagram showing a fast Fourier convolution layer, according to embodiments.

FIG. 7 is a block diagram showing a spectral transform layer, according to embodiments.

FIG. 8 is a block diagram showing a Fourier unit, according to embodiments.

FIGS. 9A-9B are flow charts of processes for performing video prediction, according to embodiments.

FIG. 10 is a block diagram of an electronic device in a network environment, according to an embodiment.

FIG. 11 shows a system including a UE and a gNB in communication with each other.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

Embodiments are directed to systems and methods for image object removal using modulation-based image generation in consideration of a global structure of an image. In order to accomplish this, embodiments may use a dual-stream network structure, in which cascaded global and spatial modulation techniques enable image generation in a coarse-to-fine manner, and may also use fast Fourier-based techniques to learn the texture of the image.

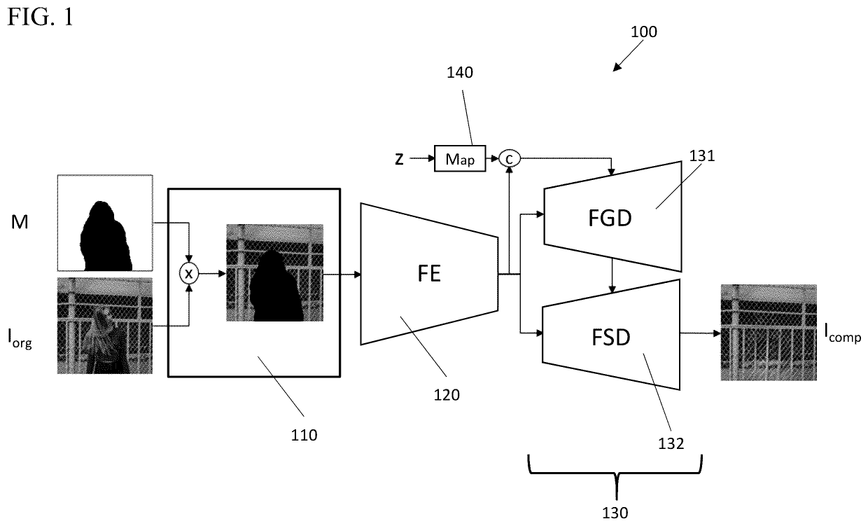

FIG. 1 is a block diagram showing an image object removal system, according to embodiments. As shown in FIG. 1, the image object removal system 100 may include a masking module 110, a Fourier-based encoder 120, a Fourier-based cascaded global-spatial decoder 130, and a mapping network 140. The cascaded decoder 130 may include both a Fourier-based global decoder 131 specializing in global feature learning, as well as a Fourier-based spatial decoder 132 specializing in spatial feature learning, which may allow the image object removal system 100 to generate image content in a coarse-to-fine manner.

In embodiments, the cascaded decoder 130 may correspond to a generator of a generative adversarial network (GAN). To enlarge the receptive field, embodiments may use fast Fourier convolution (FFC) in the encoder 120, the global decoder 131, and the spatial decoder 132, in order to allow the network to attend to the entire feature map. This may enable feature propagation even at early stages of the encoder 120, which may allow embodiments to generate repeating patterns in the missing region of the image.

In embodiments, the masking module 110 may receive an input image I_{org}, which may be a red-green-blue (RGB) image and a binary mask M, which may specify or otherwise indicate objects or other user-defined areas which are to be removed from the input image I_{org}. In some embodiments, the binary mask M may be, for example, an image or list which includes a binary value corresponding to each pixel in the image input image I_{org}, wherein the binary value indicates whether the corresponding pixel should be masked (e.g., removed, replaced with a blank pixel, or replaced with a pixel having a predetermined value). However, embodiments are not limited thereto, and in some embodiments the masking module 110 may receive mask that indicates the pixels to be masked in some other manner, for example using an equation or other relation, a list of pixel locations to be masked, a range of pixel locations to be masked, etc.

In some embodiments, the masking module 110 may generate a four-channel input corresponding to the RGB image I_{org} and the mask M, which may be referred to for example as a masked image. The masked image may be fed into the encoder 120, which may project the masked image into a latent space, and the mapping network 140 may map a noise vector z into latent space. The output of the encoder 120 and the mapping module 140 may then be used by the decoder 130 to generate image content for missing areas in the masked image. This image content may be used to generate a composed image I_{comp}, which may be an image which corresponds to the input image I_{org}, but which does not include the object.

In embodiments, the image object removal system 100 may be trained using the loss functions shown in Equations 1-3 below:

$${ℒ}_{HRFPL} = {\sum }_{p = 0}^{P - 1} \frac{{‖ {Ψ}_{p}^{{I}_{comp}} - {Ψ}_{p}^{{I}_{org}} ‖}_{2}}{N} , \qquad Equation 1$$

$${ℒ}_{rec} = {‖ {I}_{comp} - {I}_{org} ‖}_{1} \qquad Equation 2$$

$${ℒ}_{total} = {ℒ}_{adv} + {λ}_{rec} {ℒ}_{rec} + {λ}_{HRFPL} {ℒ}_{HRFPL} \qquad Equation 3$$

In Equations 1-3 above, [symbol] _{HRFPL} may denote a high receptive field perceptual loss, which may be obtained by providing the input image I_{org} and the composed image I_{comp} to a pre-trained network such as a segmentation loss having P layers, where ψₚ denotes feature map of the p^{th} layer and N denotes the number of feature points in ψ. In addition, [symbol] _{rec} may denote a reconstruction loss for the composed image I_{comp} with respect to the input image I_{org}, and [symbol] ₜₒₜₐₗ may denote the overall loss, with λ_{rec} and λ_{HRFPL} denoting scaling factors, and [symbol] _{adv} may denote an adversarial loss used to train the encoder 120 and the cascaded decoder 130.

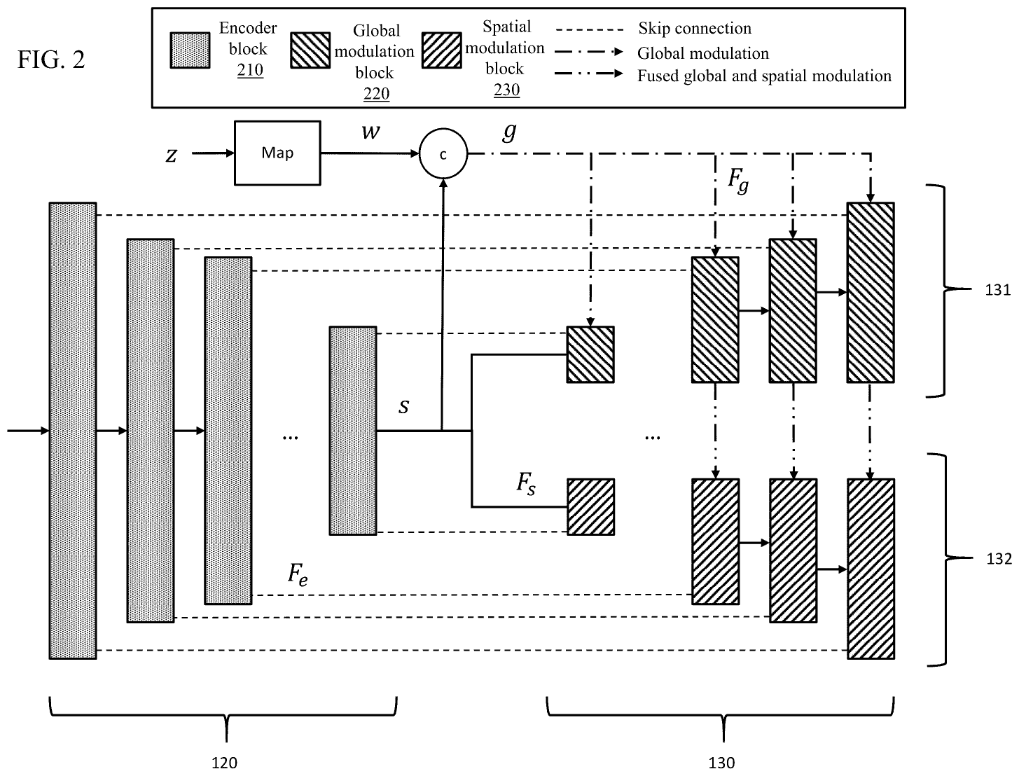

FIG. 2 is a block diagram showing an encoder and a cascaded decoder included in an image object removal system, according to embodiments. As shown in FIG. 2, the encoder 120 may include a plurality of encoder blocks 210, the global decoder may include a plurality of global modulation blocks 220, and the spatial decoder may include a plurality of spatial modulation blocks 230.

As discussed above, in some embodiments the masked image may be fed into the encoder 120, which may project the masked image into a latent space, for example by generating a latent feature vector. In embodiments, the latent feature vector may be referred to as a global style vector s. In addition, the mapping network 140 may project the noise vector z into latent space, for example by generating a noisy style vector w. Then, the noisy style vector w may be concatenated with the global style vector s to generate a global vector g.

In embodiments, the global style vector s obtained from the encoder 120 may be fed to both the global decoder 131 and the spatial decoder 132 in parallel. In addition, the global vector g may be fed to the global decoder 131, and an output of the global decoder 131 may be fed to the spatial decoder 132. The global decoder 131 and the spatial decoder 132 may upsample global features F_{g} and the spatial features Fₛ through the global modulation blocks 220 and the spatial modulation blocks 230, respectively. Examples of the global modulation blocks 220 and the spatial modulation blocks are described in greater detail below 230. In embodiments, the cascaded decoder 130 may also use skipped features Fₑ corresponding to skip connections between the encoder 120 and the cascaded decoder 130.

In embodiments, the global code g may modulate both global modulation blocks 220 and spatial modulation blocks 230 to generate better semantic structure. For example, in embodiments, a spatial code generated by the global decoder 131 may be further used to modulate the spatial decoder 132. According to embodiments, to integrate the learned global features F_{g} and the spatial features Fₛ, the global decoder 131 and the spatial decoder 132 may be cascaded such that the global content from the global modulation blocks 220 is injected to the subsequent spatial modulation blocks 230 at each resolution level.

In some approaches, the convolutional layer learns features locally due to its limited receptive field. A deep convolutional model still suffers from slow growth of the receptive fields leading to inferior features, especially at early stages of the network. To enlarge the receptive field, embodiments may use fast Fourier convolution (FFC) to attend to the entire previous feature maps. This may enable feature propagation, even at early stages of the encoder 120, to learn the features from the entire image and generate repeating patterns in the missing region of the image. According to embodiments, FFC may be utilized in the encoder 120, the global decoder 131, and the spatial decoder 132 in order to learn multi-scale feature representation. Examples of the use of FFC are described in greater detail below.

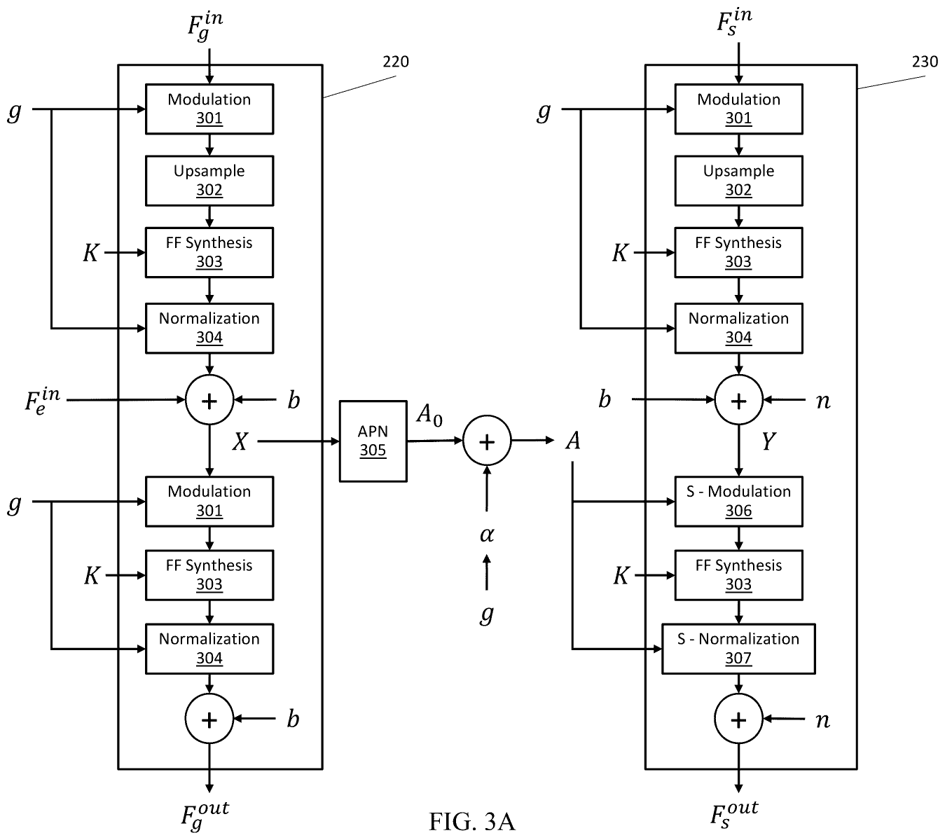

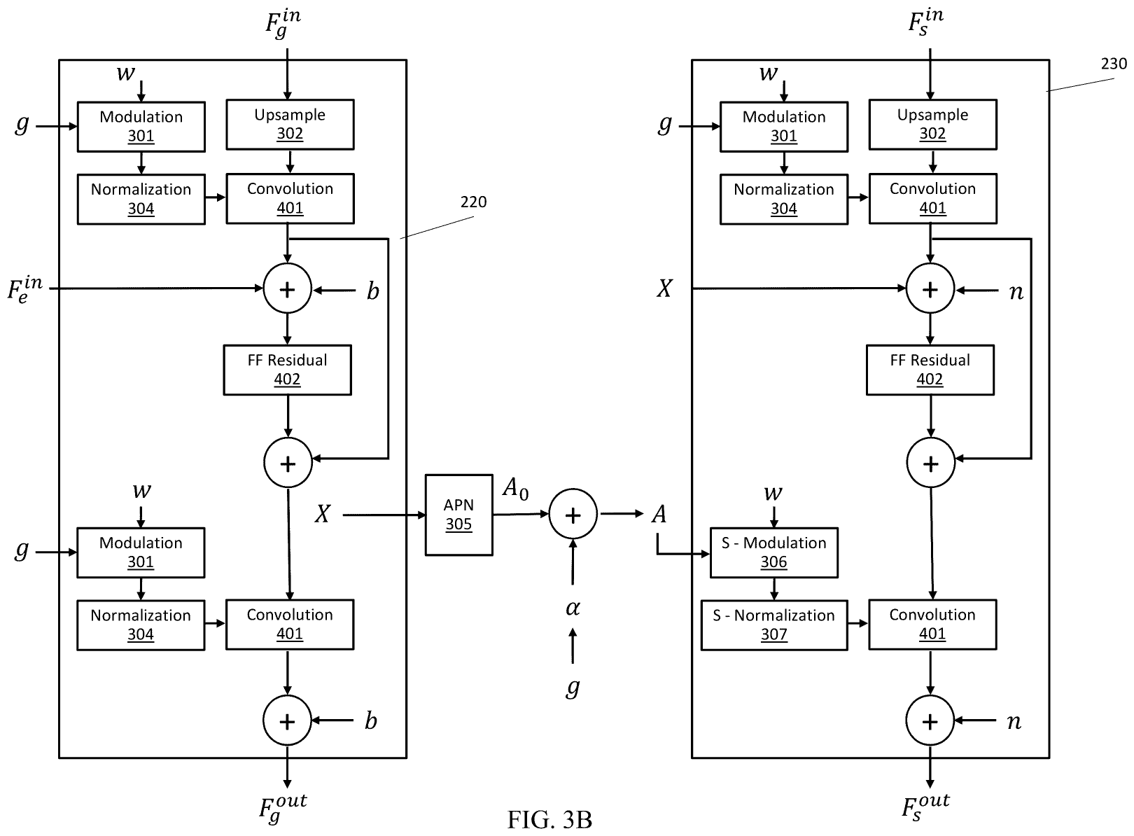

FIG. 3A is a block diagram showing global modulation block cascaded with a spatial modulation block, according to embodiments. As shown in FIG. 3A, a paralleled global modulation block 220 and spatial modulation block 230 pair may be bridged by spatial modulation.

In embodiments, the parallel blocks may receive features F_{g}ⁱⁿ and Fₛⁱⁿ as input, and may output features F_{g}^{out} and Fₛ^{out} as output. In particular, the global modulation block 220 may use modulation layers 301, an upsample layer 302, fast Fourier (FF) synthesis layers 303, and normalization layers 304 to generate an intermediate feature X and global output F_{g}^{out}. The global modulation block 220 may be modulated by the global vector g to capture the global context. In embodiments, b and n may denote noise.

Due to the limited expressive power of the global vector g to represent a 2-dimensional scene such as the masked image, and the noisy invalid features inside missing areas, the global modulation block 220 alone may generate distorted features, which may lead for example to visual artifacts such as large color blobs and incorrect structure. To correct these issues, the global modulation block 220 may be cascaded with the spatial modulation block 230 to correct invalid features while further injecting spatial details. In embodiments, the spatial modulation block 230 may also receive the global vector g to synthesize local details while respecting global context. For example, taking the spatial feature Fₛⁱⁿ as input, the spatial modulation block 230 may first produce an initial upsampled feature Y with an upsampling layer 302 modulated by global vector g. Next, Y may be jointly modulated by X and g.

For example, a spatial tensor A₀=APN(X) may be produced based on feature intermediate feature X by an affine parameter network (APN) 305. In addition, a global vector a may be generated from the global vector g using a fully connected layer to incorporate the global context. Then, a spatially-aware modulation process may be performed on a fused spatial tensor A=A₀+α by spatially-aware modulation layer 306 using both global and spatial information extracted from g and X, respectively, to scale the intermediate feature Y with element-wise product convolution according to Equation 4 below:

$$\overline{Y} = Y ⊙ A \qquad Equation 4$$

An FFC process may then be performed on the modulated tensor Y̅ by FF synthesis module 303 using a learnable kernel K according to Equation 5 below:

$$\hat{Y} = \overline{Y} * K \qquad Equation 5$$

Then, a spatially-aware normalization process may be performed using spatially-aware normalization layer 307 (illustrated as “S-Normalization”) to generate \tilde{Y} according to Equations 6 and 7 below:

$$\tilde{Y} = \hat{Y} ⊙ D \qquad Equation 6$$

$$D = 1 / \sqrt{{K}^{2} ⊙ {𝔼}_{α ∈ A} [ {α}^{2} ]} \qquad Equation 4$$

Then, the spatial output Fₛ^{out} may be determined according to Equation 8 below:

$${F}_{s}^{out} = \tilde{Y} + n \qquad Equation 8$$

Accordingly, the cascaded spatial modulation block 230 block may help to generate fine-grained visual details and improve the consistency of the composed image I_{comp} inside and outside the of the missing areas.

FIG. 3B is a block diagram showing another example of a global modulation block cascaded with a spatial modulation block, according to embodiments. Similar to FIG. 3A, as shown in FIG. 3B, a paralleled global modulation block 220 and spatial modulation block 230 pair may be bridged by spatial modulation. In embodiments, the global modulation block 220 and spatial modulation block 230 pair illustrated in FIG. 3B, and many of the elements included therein, may be similar to elements illustrated in FIG. 3A, and redundant or duplicative description thereof is omitted. However, as shown in FIG. 3B, one or more of the FF synthesis layers 303 may be replaced with convolution layers 401 and FF residual layers 402, examples of which are described in greater detail below, and the arrangement of some of the elements may be different from the arrangement shown in FIG. 3A. In some embodiments, the normalization layers 304 may be referred to as demodulation layers, and the spatially-aware normalization layers 307 may be referred to as spatially-aware demodulation layers. In some embodiments, the convolution layers 401 may be 3×3 convolution layers, but embodiments are not limited thereto.

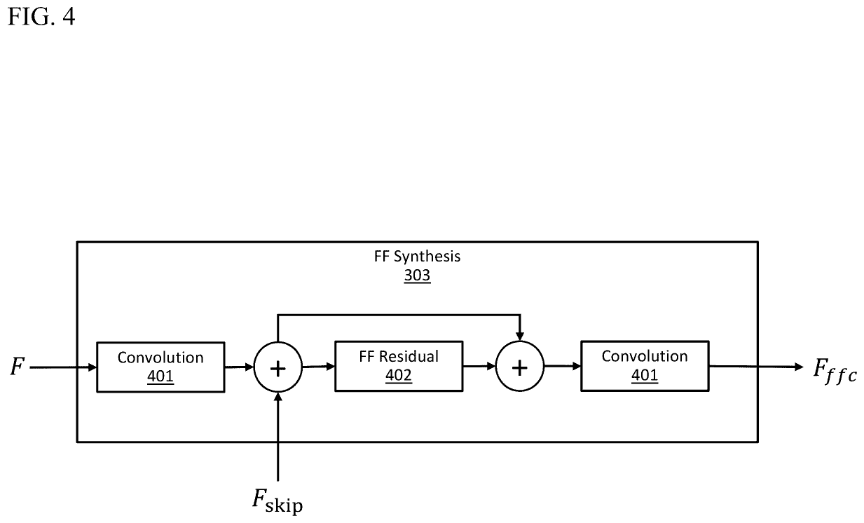

FIGS. 4 to 7 are block diagrams showing an example of an FF synthesis layer, according to embodiments. In particular, as can be seen in FIG. 4, the FF synthesis layer 303 may include convolution layers 401 and an FF residual layer 402. In embodiments, the FF synthesis layer 303 may receive a feature F and a skipped feature Fₛₖᵢₚ corresponding to a skip connection between the encoder 120 and the cascaded decoder 130, and may output a fast Fourier convolved feature F_{ffc}.

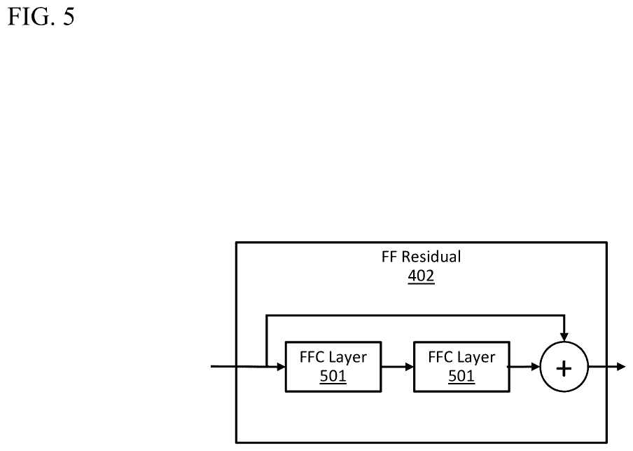

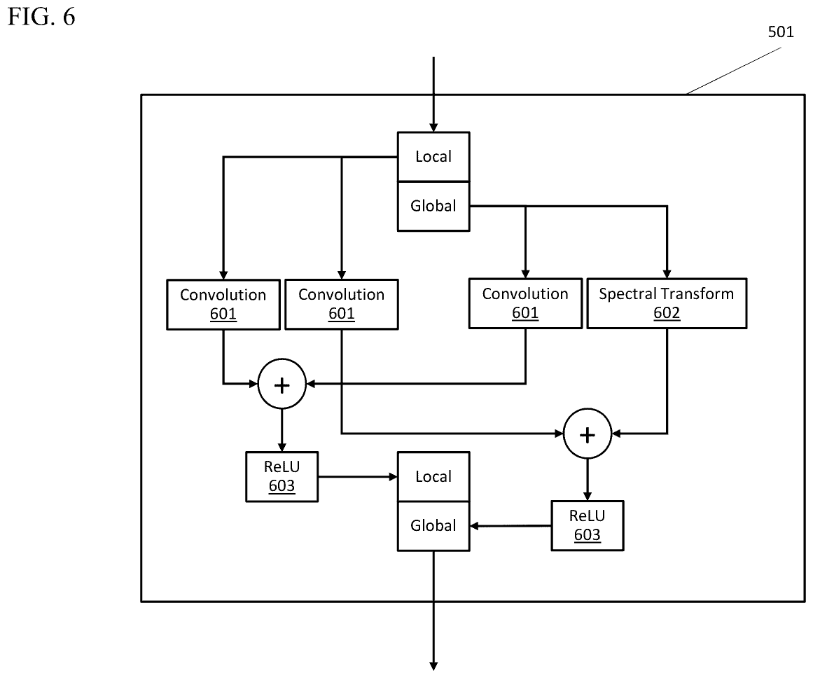

As can be seen in FIG. 5, the FF residual layer 402 may include a plurality of FFC layers 501. Still further, as can be seen in FIG. 6, an FFC layer 501 may include a plurality of convolution layers 601, a plurality of rectified linear unit (ReLU) layers 603, and a spectral transform layer 602. In embodiments, an FFC layer 501 may receive local and global inputs, and may use the plurality of convolution layers 601, the plurality of ReLU layers 603, and the spectral transform layer 602 to generate local and global outputs.

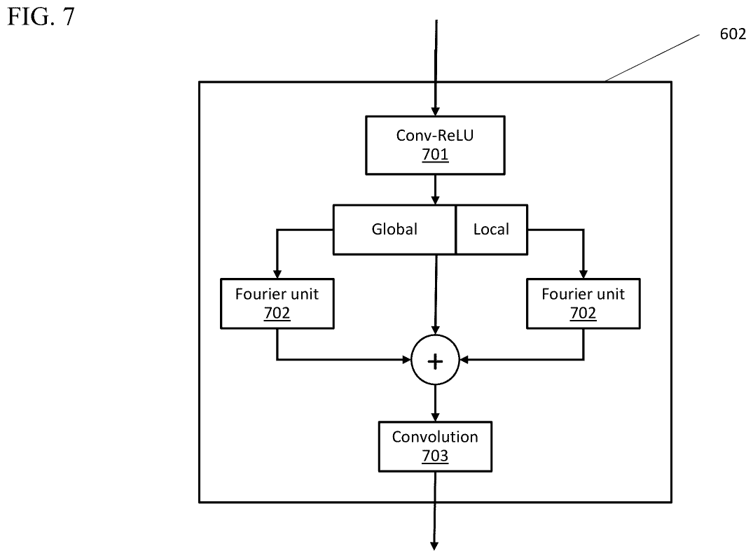

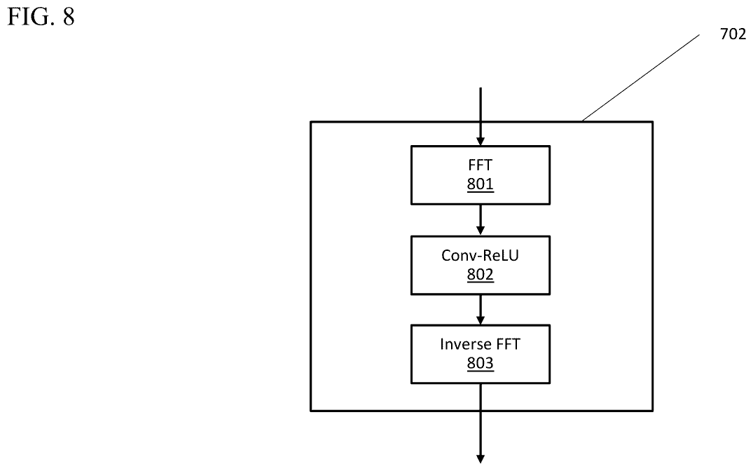

As can be seen in FIG. 7, the spectral transform layer 602 may include a convolutional-ReLU layer 701, two Fourier units 702 corresponding to a local branch and a global branch, and a convolution layer 703. As can be seen in FIG. 8, a Fourier unit 702 may include a fast Fourier transform (FFT) layer 801 configured to perform an FFT operation, a convolutional-ReLU layer 802 configured to perform a convolution operation in the frequency domain, and an inverse FFT layer 803 configured to perform an inverse FFT operation on an output of the convolutional-ReLU layer 802.

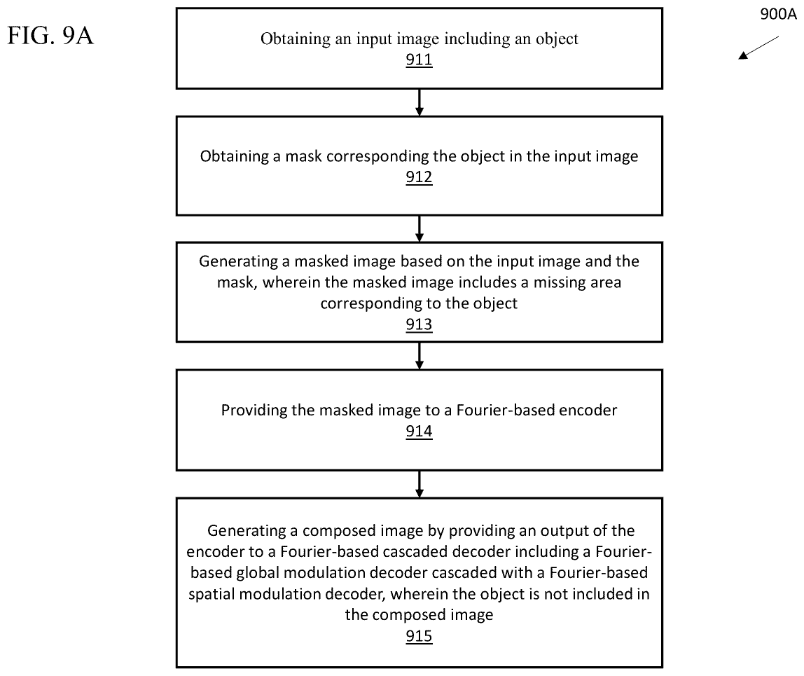

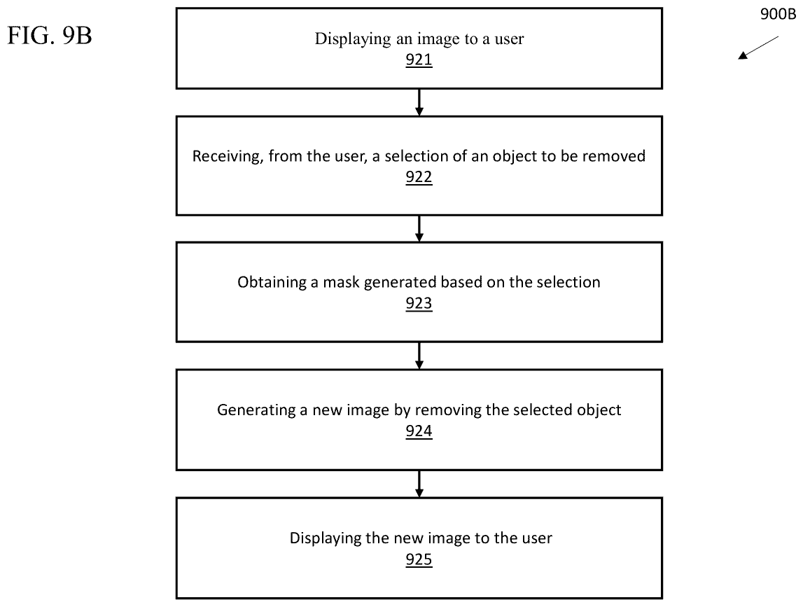

FIG. 9A is a flow chart of a process for performing image object removal, according to embodiments. In some implementations, one or more process blocks of FIG. 9A may be performed by one or more of the elements discussed above, for example one or more of the image object removal system 100 and any of the elements included therein.

As shown in FIG. 9A, at operation 911 the process 900A may include obtaining an input image including an object.

As further shown in FIG. 9A, at operation 912 the process 900A may include obtaining a mask corresponding the object in the input image. In some embodiments, the mask may correspond to the binary mask M discussed above.

As further shown in FIG. 9A, at operation 913 the process 900A may include generating a masked image based on the input image and the mask, wherein the masked image includes a missing area corresponding to the object.

As further shown in FIG. 9A, at operation 914 the process 900A may include providing the masked image to a Fourier-based encoder. In some embodiments, the Fourier-based encoder may correspond to the encoder 120 discussed above.

As further shown in FIG. 9A, at operation 915 the process 900A may include generating a composed image by providing an output of the encoder to a Fourier-based cascaded decoder including a Fourier-based global modulation decoder cascaded with a Fourier-based spatial modulation decoder, wherein the object is not included in the composed image. In some embodiments, the Fourier-based cascaded decoder may correspond to the cascaded decoder 130, the Fourier-based global modulation decoder may correspond to the global decoder 131, and the Fourier-based spatial modulation decoder may correspond to the spatial decoder 132 discussed above.

In embodiments, each of the encoder, the global modulation decoder, and the spatial modulation decoder may include at least one fast Fourier convolution layer.

In embodiments, the at least one fast Fourier convolution layer may be used to generate repeating patterns in the missing area of the input image.

In embodiments, the cascaded decoder may correspond to a generator of a generative adversarial network.

In embodiments, the output of the encoder may include a global style vector which is concatenated with a noisy style vector to generate a global vector, the global style vector and the global vector may be provided to the global modulation decoder, and the global style vector and an output of the global modulation decoder may be provided to the spatial modulation decoder.

In embodiments, the cascaded decoder may include a plurality of global modulation blocks and a plurality of spatial modulation blocks, and each global modulation block from among the plurality of global modulation blocks may be bridged to a corresponding spatial modulation block from among the plurality of spatial modulation blocks. In embodiments, the plurality of global modulation blocks may correspond to the global modulation blocks 220, and the plurality of spatial modulation blocks may correspond to the spatial modulation blocks discussed above.

In embodiments, the process 900A may further include generating global output features based on the global vector using the plurality of global modulation blocks; providing the global output features to the plurality of spatial modulation blocks; and correcting distortions in the global output features and injecting spatial details into the global output features based on the global style vector using the plurality of spatial modulation blocks.

In embodiments, each global modulation block and each spatial modulation block may include at least one fast Fourier convolution layer. In embodiments, the at least one fast Fourier convolution layer may correspond to the FF synthesis module 303 discussed above, or any of the elements included therein.

In embodiments, the process 900A may further include: performing a fast Fourier transform operation using the at least one fast Fourier convolution layer; performing a convolution operation on an output of the fast Fourier transform operation using the at least one fast Fourier convolution layer; and performing an inverse fast Fourier transform on an output of the convolution operation using the at least one fast Fourier convolution layer.

FIG. 9B is a flow chart of a process for performing image object removal, according to embodiments. In some implementations, one or more process blocks of FIG. 9B may be performed by one or more of the elements discussed above, for example one or more of the image object removal system 100 and any of the elements included therein.

As shown in FIG. 9B, at operation 921 the process 900B may include displaying an image to a user. In some embodiments, the image may correspond to the input image discussed above.

As further shown in FIG. 9B, at operation 922 the process 900B may include receiving, from the user, a selection of an object to be removed. For example, in some embodiments the image may be displayed on a screen or display of an electronic device, and the user may use an input interface of the electronic device, for example a touchscreen, a button, a mouse, a keyboard, etc., to select an object or area for removal from the image.

As further shown in FIG. 9B, at operation 923 the process 900B may include obtaining a mask generated based on the selection. In some embodiments, operation 923 may correspond to operation 912 discussed above. For example, in some embodiments the mask may correspond to the binary mask M discussed above.

As further shown in FIG. 9B, at operation 924 the process 900B may include generating a new image by removing the selected object. In some embodiments, operation 924 may correspond to some or all of operations 913, 914, and 915 discussed above. For example, in some embodiments, the new image may correspond to the composed image discussed above.

As further shown in FIG. 9B, at operation 925 the process 900B may include displaying the new image to the user.

Although FIGS. 9A-9B show example blocks of processes 900A and 900B, in some implementations, processes 900A and 900B may include additional blocks, fewer blocks, different blocks, or differently arranged blocks than those depicted in FIGS. 9A-9B. Additionally, or alternatively, two or more of the blocks of processes 900A and 900B may be performed in parallel.

Accordingly, embodiments are directed to an image object removal system having a dual-stream network structure, in which cascaded global and spatial modulation techniques enable image generation in a coarse-to-fine manner. The image object removal system may utilize fast Fourier-based techniques that may enlarge the receptive field in both the encoder and the decoder of the network structure.

In addition, embodiments may be directed to a modulation-based object removal method, in which the geometric structure and object boundaries within missing regions of an image are obtained using a coarse-to-fine GAN-based network. Texture synthesis may be learned using fast Fourier convolution in an encoder and in multiple decoders included in the network structure. As a result, embodiments may effectively handle both the structure and the texture of the image, and may achieve realistic results for missing regions with any shapes or sizes.

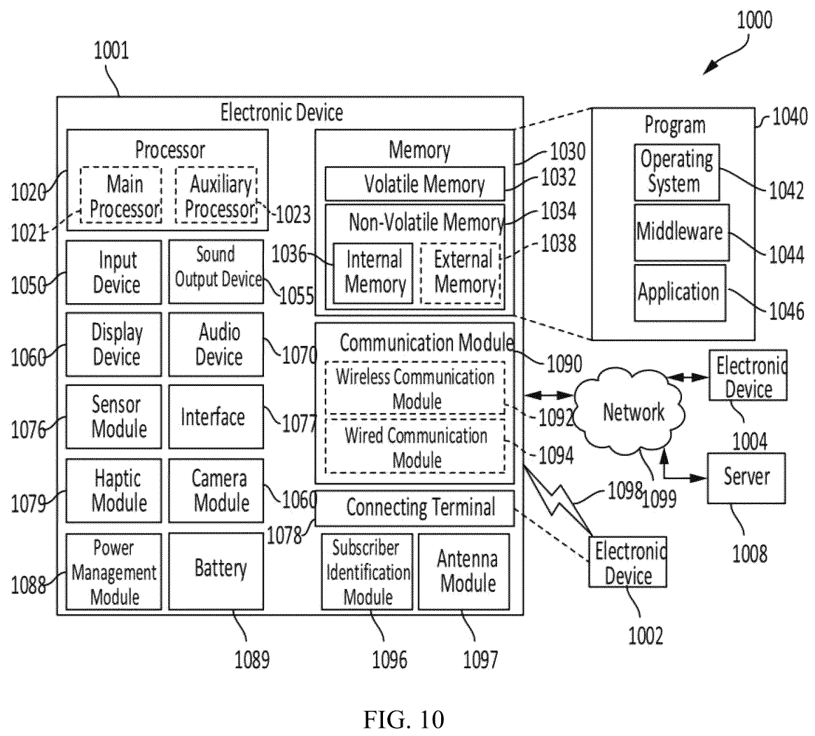

FIG. 10 is a block diagram of an electronic device in a network environment 1000, according to an embodiment.

Referring to FIG. 10, an electronic device 1001 in a network environment 1000 may communicate with an electronic device 1002 via a first network 1098 (e.g., a short-range wireless communication network), or an electronic device 1004 or a server 1008 via a second network 1099 (e.g., a long-range wireless communication network). The electronic device 1001 may communicate with the electronic device 1004 via the server 1008. The electronic device 1001 may include a processor 1020, a memory 1030, an input device 1050, a sound output device 1055, a display device 1060, an audio module 1070, a sensor module 1076, an interface 1077, a haptic module 1079, a camera module 1080, a power management module 1088, a battery 1089, a communication module 1090, a subscriber identification module (SIM) card 1096, or an antenna module 1097. In one embodiment, at least one (e.g., the display device 1060 or the camera module 1080) of the components may be omitted from the electronic device 1001, or one or more other components may be added to the electronic device 1001. Some of the components may be implemented as a single integrated circuit (IC). For example, the sensor module 1076 (e.g., a fingerprint sensor, an iris sensor, or an illuminance sensor) may be embedded in the display device 1060 (e.g., a display).

The processor 1020 may execute software (e.g., a program 1040) to control at least one other component (e.g., a hardware or a software component) of the electronic device 1001 coupled with the processor 1020 and may perform various data processing or computations.

As at least part of the data processing or computations, the processor 1020 may load a command or data received from another component (e.g., the sensor module 1076 or the communication module 1090) in volatile memory 1032, process the command or the data stored in the volatile memory 1032, and store resulting data in non-volatile memory 1034. The processor 1020 may include a main processor 1021 (e.g., a central processing unit (CPU) or an application processor (AP)), and an auxiliary processor 1023 (e.g., a graphics processing unit (GPU), an image signal processor (ISP), a sensor hub processor, or a communication processor (CP)) that is operable independently from, or in conjunction with, the main processor 1021. Additionally or alternatively, the auxiliary processor 1023 may be adapted to consume less power than the main processor 1021, or execute a particular function. The auxiliary processor 1023 may be implemented as being separate from, or a part of, the main processor 1021.

The auxiliary processor 1023 may control at least some of the functions or states related to at least one component (e.g., the display device 1060, the sensor module 1076, or the communication module 1090) among the components of the electronic device 1001, instead of the main processor 1021 while the main processor 1021 is in an inactive (e.g., sleep) state, or together with the main processor 1021 while the main processor 1021 is in an active state (e.g., executing an application). The auxiliary processor 1023 (e.g., an image signal processor or a communication processor) may be implemented as part of another component (e.g., the camera module 1080 or the communication module 1090) functionally related to the auxiliary processor 1023.

The memory 1030 may store various data used by at least one component (e.g., the processor 1020 or the sensor module 1076) of the electronic device 1001. The various data may include, for example, software (e.g., the program 1040) and input data or output data for a command related thereto. The memory 1030 may include the volatile memory 1032 or the non-volatile memory 1034. Non-volatile memory 1034 may include internal memory 1036 and/or external memory 1038.

The program 1040 may be stored in the memory 1030 as software, and may include, for example, an operating system (OS) 1042, middleware 1044, or an application 1046.

The input device 1050 may receive a command or data to be used by another component (e.g., the processor 1020) of the electronic device 1001, from the outside (e.g., a user) of the electronic device 1001. The input device 1050 may include, for example, a microphone, a mouse, or a keyboard.

The sound output device 1055 may output sound signals to the outside of the electronic device 1001. The sound output device 1055 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 1060 may visually provide information to the outside (e.g., a user) of the electronic device 1001. The display device 1060 may include, for example, a display, a hologram device, or a projector and control circuitry to control a corresponding one of the display, hologram device, and projector. The display device 1060 may include touch circuitry adapted to detect a touch, or sensor circuitry (e.g., a pressure sensor) adapted to measure the intensity of force incurred by the touch.

The audio module 1070 may convert a sound into an electrical signal and vice versa. The audio module 1070 may obtain the sound via the input device 1050 or output the sound via the sound output device 1055 or a headphone of an external electronic device 1002 directly (e.g., wired) or wirelessly coupled with the electronic device 1001.

The sensor module 1076 may detect an operational state (e.g., power or temperature) of the electronic device 1001 or an environmental state (e.g., a state of a user) external to the electronic device 1001, and then generate an electrical signal or data value corresponding to the detected state. The sensor module 1076 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1077 may support one or more specified protocols to be used for the electronic device 1001 to be coupled with the external electronic device 1002 directly (e.g., wired) or wirelessly. The interface 1077 may include, for example, a high-definition multimedia interface (HDMI), a universal serial bus (USB) interface, a secure digital (SD) card interface, or an audio interface.

A connecting terminal 1078 may include a connector via which the electronic device 1001 may be physically connected with the external electronic device 1002. The connecting terminal 1078 may include, for example, an HDMI connector, a USB connector, an SD card connector, or an audio connector (e.g., a headphone connector).

The haptic module 1079 may convert an electrical signal into a mechanical stimulus (e.g., a vibration or a movement) or an electrical stimulus which may be recognized by a user via tactile sensation or kinesthetic sensation. The haptic module 1079 may include, for example, a motor, a piezoelectric element, or an electrical stimulator.

The camera module 1080 may capture a still image or moving images. The camera module 1080 may include one or more lenses, image sensors, image signal processors, or flashes. The power management module 1088 may manage power supplied to the electronic device 1001. The power management module 1088 may be implemented as at least part of, for example, a power management integrated circuit (PMIC).

The battery 1089 may supply power to at least one component of the electronic device 1001. The battery 1089 may include, for example, a primary cell which is not rechargeable, a secondary cell which is rechargeable, or a fuel cell.

The communication module 1090 may support establishing a direct (e.g., wired) communication channel or a wireless communication channel between the electronic device 1001 and the external electronic device (e.g., the electronic device 1002, the electronic device 1004, or the server 1008) and performing communication via the established communication channel. The communication module 1090 may include one or more communication processors that are operable independently from the processor 1020 (e.g., the AP) and supports a direct (e.g., wired) communication or a wireless communication. The communication module 1090 may include a wireless communication module 1092 (e.g., a cellular communication module, a short-range wireless communication module, or a global navigation satellite system (GNSS) communication module) or a wired communication module 1094 (e.g., a local area network (LAN) communication module or a power line communication (PLC) module). A corresponding one of these communication modules may communicate with the external electronic device via the first network 1098 (e.g., a short-range communication network, such as BLUETOOTH™, wireless-fidelity (Wi-Fi) direct, or a standard of the Infrared Data Association (IrDA)) or the second network 1099 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 1092 may identify and authenticate the electronic device 1001 in a communication network, such as the first network 1098 or the second network 1099, using subscriber information (e.g., international mobile subscriber identity (IMSI)) stored in the SIM card 1096.

The antenna module 1097 may transmit or receive a signal or power to or from the outside (e.g., the external electronic device) of the electronic device 1001. The antenna module 1097 may include one or more antennas, and, therefrom, at least one antenna appropriate for a communication scheme used in the communication network, such as the first network 1098 or the second network 1099, may be selected, for example, by the communication module 1090 (e.g., the wireless communication module 1092). The signal or the power may then be transmitted or received between the communication module 1090 and the external electronic device via the selected at least one antenna.

Commands or data may be transmitted or received between the electronic device 1001 and the external electronic device 1004 via the server 1008 coupled with the second network 1099. Each of the electronic devices 1002 and 1004 may be a device of a same type as, or a different type, from the electronic device 1001. All or some of operations to be executed at the electronic device 1001 may be executed at one or more of the external electronic devices 1002, 1004, or 1008. For example, if the electronic device 1001 should perform a function or a service automatically, or in response to a request from a user or another device, the electronic device 1001, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 1001. The electronic device 1001 may provide the outcome, with or without further processing of the outcome, as at least part of a reply to the request. To that end, a cloud computing, distributed computing, or client-server computing technology may be used, for example.

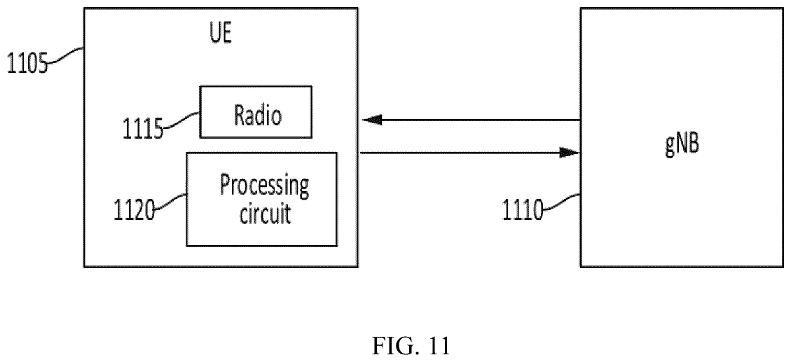

FIG. 11 shows a system including a UE 1105 and a gNB 1110, in communication with each other. The UE may include a radio 815 and a processing circuit (or a means for processing) 1120, which may perform various methods disclosed herein, e.g., the method illustrated in FIGS. 2 and 8A-8C. For example, the processing circuit 1120 may receive, via the radio 1115, transmissions from the network node (gNB) 1110, and the processing circuit 1120 may transmit, via the radio 1115, signals to the gNB 1110.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method of performing image object removal, the method being executed by at least one processor and comprising:
obtaining an input image comprising an object;
obtaining a mask corresponding the object in the input image;
generating a masked image based on the input image and the mask, wherein the masked image comprises a missing area corresponding to the object;
providing the masked image to a Fourier-based encoder; and
generating a composed image by providing an output of the encoder to a Fourier-based cascaded decoder comprising a Fourier-based global modulation decoder cascaded with a Fourier-based spatial modulation decoder,
wherein the object is not included in the composed image.

2. The method of claim 1, wherein each of the encoder, the global modulation decoder, and the spatial modulation decoder comprises at least one fast Fourier convolution layer.

3. The method of claim 2, wherein the at least one fast Fourier convolution layer is used to generate repeating patterns in the missing area of the input image.

4. The method of claim 1, wherein the cascaded decoder corresponds to a generator of a generative adversarial network.

5. The method of claim 1, wherein the output of the encoder comprises a global style vector which is concatenated with a noisy style vector to generate a global vector,
wherein the global style vector and the global vector are provided to the global modulation decoder, and
wherein the global style vector and an output of the global modulation decoder are provided to the spatial modulation decoder.

6. The method of claim 5, wherein the cascaded decoder comprises a plurality of global modulation blocks and a plurality of spatial modulation blocks, and
wherein each global modulation block from among the plurality of global modulation blocks is bridged to a corresponding spatial modulation block from among the plurality of spatial modulation blocks.

7. The method of claim 6, further comprising:
generating global output features based on the global vector using the plurality of global modulation blocks;
providing the global output features to the plurality of spatial modulation blocks; and
correcting distortions in the global output features and injecting spatial details into the global output features based on the global style vector using the plurality of spatial modulation blocks.

8. The method of claim 6, wherein each global modulation block and each spatial modulation block comprises at least one fast Fourier convolution layer.

9. The method of claim 8, wherein the method further comprises:
performing a fast Fourier transform operation using the at least one fast Fourier convolution layer; performing a convolution operation on an output of the fast Fourier transform operation using the at least one fast Fourier convolution layer; and
performing an inverse fast Fourier transform on an output of the convolution operation using the at least one fast Fourier convolution layer.

10. A system for performing image object removal, the system comprising:
a masking module configured to:
obtaining an input image comprising an object;
obtaining a mask corresponding the object in the input image;
generate a masked image based on the input image and the mask, wherein the masked image comprises a missing area corresponding to the object; and
a Fourier-based encoder configured to generate features based on the masked image; and
a Fourier-based cascaded decoder comprising a Fourier-based global modulation decoder cascaded with a Fourier-based spatial modulation decoder,
wherein the cascaded decoder is configured to generate a composed image based on the features, and
wherein the object is not included in the composed image.

11. The system of claim 10, wherein each of the encoder, the global modulation decoder, and the spatial modulation decoder comprises at least one fast Fourier convolution layer.

12. The system of claim 11, wherein the at least one fast Fourier convolution layer is used to generate repeating patterns in the missing area of the image.

13. The system of claim 10, wherein the cascaded decoder corresponds to a generator of a generative adversarial network.

14. The system of claim 10, wherein the output of the encoder comprises a global style vector which is concatenated with a noisy style vector to generate a global vector,
wherein the global style vector and the global vector are provided to the global modulation decoder, and
wherein the global style vector and an output of the global modulation decoder are provided to the spatial modulation decoder.

15. The system of claim 14, wherein the cascaded decoder comprises a plurality of global modulation blocks and a plurality of spatial modulation blocks, and
wherein each global modulation block from among the plurality of global modulation blocks is bridged to a corresponding spatial modulation block from among the plurality of spatial modulation blocks.

16. The system of claim 15, further comprising:
generating global output features based on the global vector using the plurality of global modulation blocks;
providing the global output features to the plurality of spatial modulation blocks; and
correcting distortions in the global output features and injecting spatial details into the global output features based on the global style vector using the plurality of spatial modulation blocks.

17. The system of claim 15, wherein each global modulation block and each spatial modulation block comprises at least one fast Fourier convolution layer.

18. The system of claim 17, wherein the method further comprises:
performing a fast Fourier transform operation using the at least one fast Fourier convolution layer; performing a convolution operation on an output of the fast Fourier transform operation using the at least one fast Fourier convolution layer; and
performing an inverse fast Fourier transform on an output of the convolution operation using the at least one fast Fourier convolution layer.

19. A non-transitory computer-readable medium configured to store instructions which, when executed by at least one processor of an electronic device for performing image object removal, causes the at least one processor to:
obtain an input image comprising an object;
obtain a mask corresponding the object in the input image;
generate a masked image based on the input image and the mask, wherein the masked image comprises a missing area corresponding to the object;
provide the masked image to a Fourier-based encoder; and
generate a composed image by providing an output of the encoder to a Fourier-based cascaded decoder comprising a Fourier-based global modulation decoder cascaded with a Fourier-based spatial modulation decoder,
wherein the object is not included in the composed image.

20. The method of claim 19, wherein each of the encoder, the global modulation decoder, and the spatial modulation decoder comprises at least one fast Fourier convolution layer.
